(19) United States
(12) Patent Application Publication
(10) Pub. No.: US 2014/0015365 A1
(43) Pub. Date: Jan. 16, 2014

(54) Electromagnetic High Frequency Homopolar Generator

(71) Applicant: Vadim Harenco, Los Angeles, CA (US)

(72) Inventor: Vadim Harenco, Los Angeles, CA (US)

(73) Assignee: Vadim Harenco, Los Angeles, CA (US)

(21) Appl. No.: 13/548,119

(22) Filed: Jul. 12, 2012

(51) Int. Cl. H02K 17/42

(52) U.S. Cl. 310/159

(57) ABSTRACT

Electromagnetic high frequency homopolar generator is a type of homopolar generator that can continuously transform kinetic energy into high frequency current. Operating frequency of this generator is independent from speed of rotation. Due to high frequency, power from this generator can be easily distributed by transformers. It is known that the higher frequency of the current is, the smaller core for the transformer is required. Generator, described herein, is operating on its resonant frequency, increasing voltage in the armature circuit. Where a large power source of a high frequency is needed, my generator can replace devices, which use semiconductors to convert current from direct to high frequency.

### BACKGROUND OF THE INVENTION

This invention is related to that class of electromagnetic generators variously known as “unipolar”,“homopolar” or “monopolar” machine, in which a disk or a cylinder is mounted between magnetic poles to induce electromotive force by rotating in either direction. Direction of the current will depend on the direction of rotation and the sign of magnetic poles. These machines usually generate high current with low volts that is why they have a very limited use.

The principle of operation of my improved generator may be associated with synchrotron, a cyclic particle accelerator, in which a particle is moving along the constant length of the orbit and accelerating magnetic and electric field is being synchronized with a particle beam, increasing the kinetic energy of the particles. Like particle beam in synchrotron that is always moving along its orbit in one direction, armature in my generator always rotating in one direction. The difference is that my generator uses kinetic energy and magnetic field to generate current.

I came up with a solution to make homopolar generators more usable by forcing them to generate high frequency current that is independent from speed of rotation. It is obvious that with this improvement it will be possible to transfer power by using high frequency transformers, which are significantly smaller than low frequency transformers.

Right now to produce electric current of a high frequency, semiconductors, such as transistors, are used. With a help of transistors direct current can be converted into high frequency current. However, power of these converters is limited to the specification of transistors. With my generator it will be possible to generate more power with higher frequency directly from motion with less effort.

### SUMMARY

Electromagnetic high frequency homopolar generator is related to the class of homopolar generators, as described herein. Frequency oscillation of the electric current in this generator is independent from speed of rotation and is formed by connecting in series armature, capacitor and primary coil of a transformer. Since electromagnets of stator are powered by armature electric current through the transformer, when armature is rotating in either direction, magnetic field and armature electric current changes simultaneously, allowing electric current to be generated without interruptions. Voltage in the armature circuit will be increased due to resonance. With these improvements operating frequency of this generator will be very stable and flexible and distribution of the produced energy will be easy.

### BRIEF DESCRIPTION OF THE DRAWINGS

FIG. 1 shows a side view of my improved generator and how all its components are connected together.

FIG. 2A shows direction of magnetic field and electric current in my improved generator and its components during first half of the wave period.

FIG. 2B shows direction of magnetic field and electric current in my improved generator and its components during second half of the wave period.

### DETAILED DESCRIPTION OF THE INVENTION

My electromagnetic high frequency homopolar generator is not limited with a specific construction. If homopolar generator with disk, or disks, or cylinder as a part of armature is used as a base, it will work if it fits all the necessary requirements, which I will describe here.

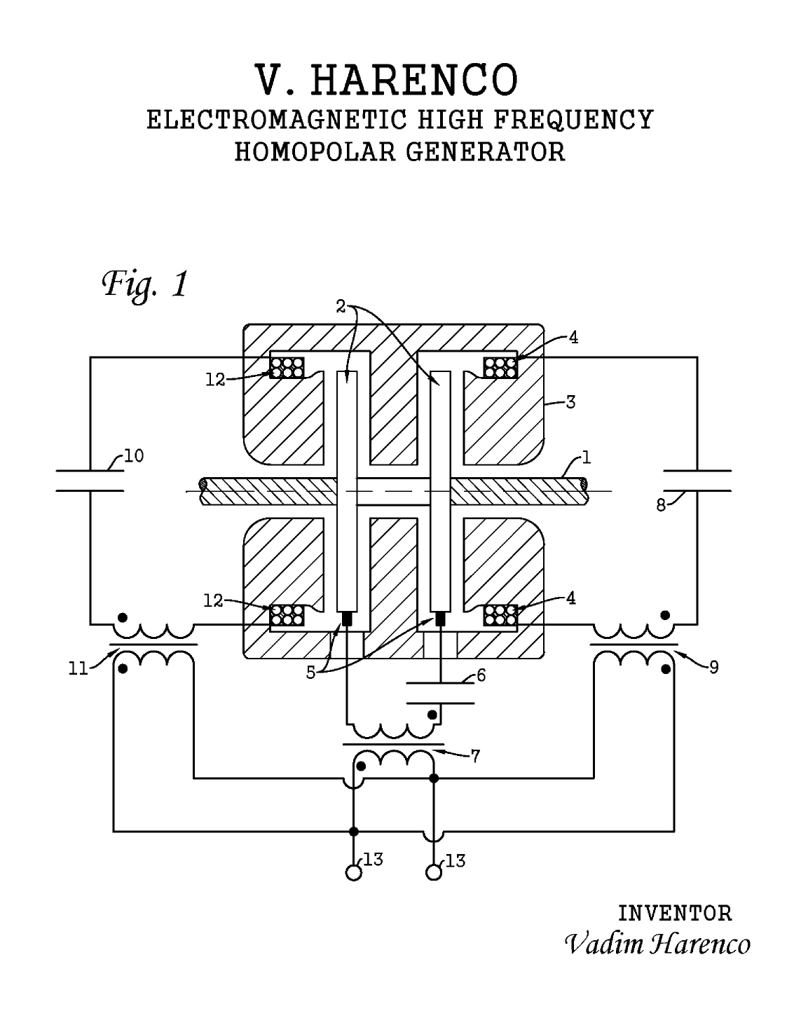

Base for my generator, shown on FIG. 1, consists: stator magnetic core 3, field coils 4 and 12, shaft 1, disks 2 and brushes 5.

Stator magnetic core 3 is made from a soft-magnetic material, like ferrite. Shaft 1 preferably should be made from non-conducting material; steel will melt due to high frequency in field coils. Disks 2 can be made from copper and they should be connected to each other in the center with a conducting material, preferably the same disks are made of. To conduct current from moving disks to stationary wires brushes 5 are used. When operating, current must flow from disks 2 to brushes 5 during all period of time without interruptions.

Armature circuit is formed by connecting together in series disks 2, brushes 5, capacitor 6 and the primary coil of the transformer 7.

Field coil 4 is connected to capacitor 8 and secondary coil of transformer 9 in series, as well as field coil 12 is connected to capacitor 10 and secondary coil of transformer 11. To transfer power to electromagnets primary coil of transformers 9 and 11 are connected to the secondary coil of transformer 7.

Power can be taken from terminals 13.

Armature circuit and circuit of electromagnets should have the same resonant frequency. It is obvious that frequency of the output power will depend on the resonant frequency of the generator.

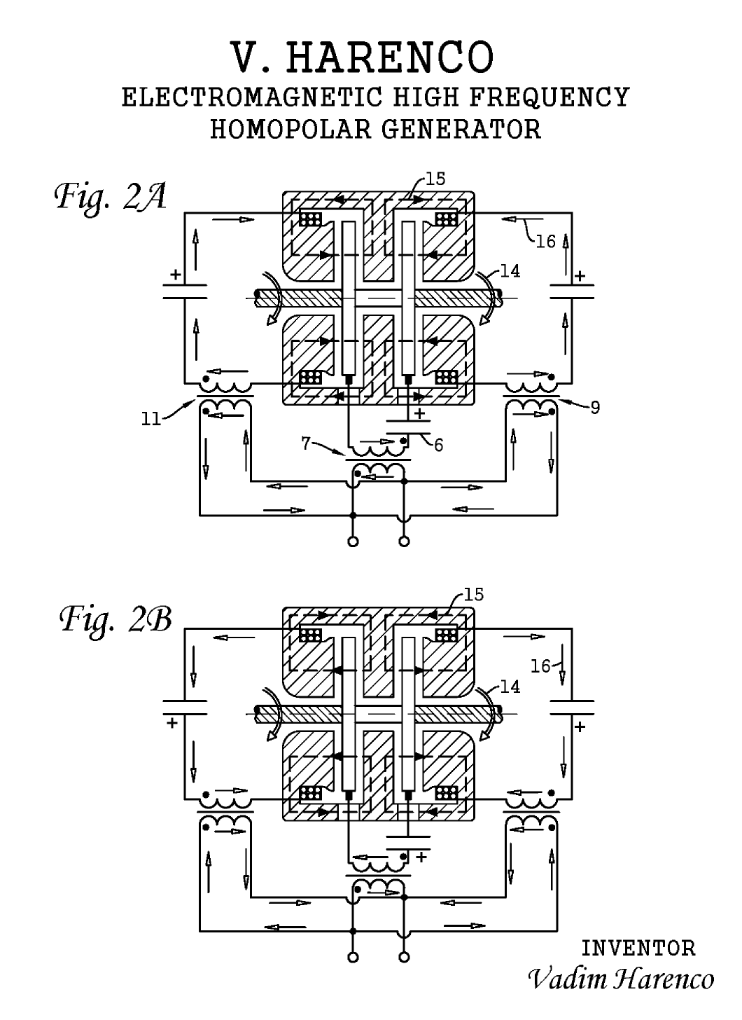

Direction of magnetic field and electric current in the generator is shown on FIG. 2A and FIG. 2B.

Let us assume that armature is rotating in direction shown on FIG. 2A as blank arrow with two tails 14 and magnetic field is flowing in direction shown as dashed arrow 15. This will generate potential difference on brushes 5 and current, shown as blank arrow 16, will flow through primary coil of the transformer 7 to the capacitor 6.

Electromagnets will receive power from transformers 9 and 11, which are connected to the secondary coil of the transformer 7. Direction of the current in the field coils of electromagnets must generate magnetic field with a direction shown on FIG. 2A as dashed arrow 15, as mentioned above.

When capacitor 6 will be fully charged, current will stop flowing through transformer 7 and, as a result, electromagnets will stop generate magnetic field. This will cause current 16 in capacitor 7 to reverse its direction, as shown on FIG. 2B. Because current in the primary coil of the transformer 7 will change its direction, current of the field coils 4 and 12 will also change direction and magnetic field 15 will be reversed, inducing electromotive force in disks 2. It is obvious that current, induced by electromotive force will have the same direction as current that is flowing back from capacitor. Because all components of the armature circuit are connected in series, voltage will be increased due to voltage resonance. Because I use capacitor in a circuit of electromagnets, resonant frequency of both, armature circuit and circuit of electromagnets, should be the same, as I mentioned herein.

Arrow 14 on FIG. 2B indicates that direction of rotation of the armature does not change during process of generation.

Because homopolar generators are capable to produce very high current with low volts, primary coil of the transformer 7 should have only a few turns and wire should be capable to transfer high current, but resistance of the coil should not be less than resistance of disks.

Due to high frequency current, brushes 5 must be able to work in high frequency field and there may be difficulties to replace them with liquid metal brushes.

Generator, which I generally described, is not a self-starting generator. The easiest method to start this generator is to apply current of the resonant to generator frequency to the output terminals 13, when disks are rotating.

The other method is to charge capacitors 10, or 8, or both with direct current, when armature is rotating. This will create magnetic field in the generator and, as a result, capacitor 6 will be charged. Oscillation will begin when direct current that charges capacitors will be stopped.

As I herein mentioned, my improved generator is not limited with a specific construction, shown on FIG. 1. Transformers 7, 9 and 11 could be joined in one single transformer, for better view I decided to show them separated. Capacitors 8 and 10 are not very necessary, but I believe they will increase stability of the process of generating electric current. Disk, or disks, or cylinder can be used in my generator as part of the armature. However, I do not recommend using armature cylinder, because inside cylinder soft-magnetic material must be used, usually it is ferrite and ferrite is very fragile.

Generator, described herein, can also work on low frequencies, but I do not see any benefits of it.

Generator, described herein, can also work as a motor, but it will be fragile.

What I claim is:

1. Electromagnetic high frequency homopolar generator, consisting: a stator that includes a stator magnetic core made from the soft-magnetic material and field coils of electromagnets; a rotor that includes shaft made from the non-conducting material and disks made from conducting material.

2. Electromagnetic high frequency homopolar generator of claim 1, wherein soft-magnetic material is ferrite.

3. Electromagnetic high frequency homopolar generator of claim 1, wherein circuit of each electromagnet includes connected in series field coil, capacitor and transformer, which is powered from the output of generator.

4. Electromagnetic high frequency homopolar generator of claim 3, wherein circuit of each electromagnet has its own resonant frequency, which is equal to the operating frequency of the generator.

5. Electromagnetic high frequency homopolar generator of claim 1, wherein conducting material of disks is copper.

6. Electromagnetic high frequency homopolar generator of claim 1, wherein armature circuit includes connected in series capacitor, transformer and disks.

7. Electromagnetic high frequency homopolar generator of claim 6, wherein armature circuit has its own resonant frequency, which is equal to the operating frequency of the generator.

8. Electromagnetic high frequency homopolar generator is a type of generator that is able to continuously produce high frequency current.
